(19) United States
(12) Patent Application Publication
(10) Pub. No.: US 2014/0272075 A1
(43) Pub. Date: Sep. 18, 2014

(54) Enhanced Viscosity Mustard Paste

(71) Applicant: Wisconsin Spice, Inc., Berlin, WI (US)

(72) Inventors: Allen Phillip Sass, Neenah, WI (US); Karl Arlin Spiegelberg, Green Bay, WI (US); Phillip Joseph Sass, Berlin, WI (US); Citra Putri Rahardjo, Oshkosh, WI (US)

(73) Assignee: Wisconsin Spice, Inc., Berlin, WI (US)

(21) Appl. No.: 14/206,883

(22) Filed: Mar. 12, 2014

Related U.S. Application Data
(60) Provisional application No. 61/794,856, filed on Mar. 15, 2013.

(51) Int. Cl. A23L 1/225

(52) U.S. Cl. CPC A23L 1/225
USPC 426/589

(57) ABSTRACT

An enhanced viscosity mustard paste and a method of manufacturing the same. The enhanced viscosity mustard paste can include a mustard seed and acidic liquid solvent, without a noticeable increase in mustard flavor. The enhanced viscosity mustard paste according to this invention may also be a substantially flavorless mustard paste that retains the functional benefits of viscosity-building, texture-aiding, and emulsion-strengthening.

### CROSS-REFERENCE TO RELATED APPLICATIONS

This application claims priority from U.S. Provisional Patent Application Ser. No. 61/794,856, filed on Mar. 15, 2013, the entirety of which is expressly incorporated, by reference herein.

### FIELD OF THE INVENTION

The present invention is generally directed to a mustard paste, and more particularly, relates to a mustard paste providing an increased viscosity and/or decreased flavor. The invention additionally relates to a method of manufacturing the same.

### BACKGROUND OF THE INVENTION

Traditionally prepared mustards and/or mustard pastes are used as condiments, and just as commonly are used as ingredients in sauces, dressings, and the like. They are typically formed from an aqueous suspension of mustard seeds in water and vinegar. Salts and spices may also be added to taste. Prepared mustards, and more generally mustard pastes, are milled so as to extract mucilage, the material responsible for creating viscosity and texture. Mustard pastes high in mustard seed concentration are commonly used in sauces and dressings to help strengthen emulsions and build texture, often serving as a replacement to soybean and/or canola oils in high-fat containing dressings and sauces such as mayonnaise. Mustard pastes are typically added to these products for its functional benefits, namely viscosity-building, texture-aiding, and emulsion-strengthening attributes.

It has been well documented that yellow mustard seed (S. alba or B. hirta) is a particularly effective ingredient to be used in mayonnaise and other high-fat containing dressings, particularly in conjunction with oil and/or egg reduction, due its functional benefits. Specifically, the mustard flour, or endosperm of the mustard seed, contains proteins that make it an effective emulsifier. The bran, or hull of the mustard seed, is rich in mucilage, thus, it is effective as a stabilizing agent in the aforementioned applications. The combination of emulsification (from the endosperm, or flour) and stabilization (from the bran, or hull) lead to dual benefits, making it a widely used ingredient.

Mustard pastes are commonly used as the means of incorporating mustard seed into mayonnaise, dressings, and sauces. The unique milling process employed in preparing mustard pastes is important to consider, as the unique nature of this process helps to fully extract the compounds responsible for both emulsification and stabilization. While mustard can be used in the aforementioned applications on a dry matter basis, it has been found that using an equivalent volume of mustard paste (on a solids basis) is significantly more effective in realizing the benefits of emulsification and stabilization. Thus, the need for a mustard paste.

Within the mustard industry, a common method to determine the degree of mucilage extraction, and corresponding stabilization properties in application, is to measure the viscosity. A higher viscosity value (measured using a Brookfield viscometer) can imply greater mucilage extraction, and thus increased stabilization benefits when used in application.

While mustard pastes are common in the food industry, the products readily available on the market have been composed of the same general ingredients—vinegar, water, and mustard seed. When using these common ingredients, one is limited in the degree of mucilage extraction, and corresponding stabilization benefits; however, by using a modified mustard seed, particularly one with concentrated proteins and mucilage, one can create a mustard paste with enhanced viscosity, and corresponding stabilization benefits, thus making it more effective than traditional mustard pastes. This can be accomplished by employing a specialized means of mustard seed treatment prior to mixing with other ingredients (e.g. vinegar, water, spices, etc.). Specifically, the mustard seed can be “cold pressed” to extract the fixed oil portion of the mustard seed, a material not considered functional for the given application in mayonnaise, sauces, and dressings. The resultant is a mustard seed that is considered “de-oiled”, as approximately 70% of the oil content is removed. The reduced oil content means that the other components, namely the proteins and mucilage, are concentrated, allowing for enhanced viscosity, and corresponding functional benefits, when used in making a mustard paste, and in application.

Commercially available mustard products often still possess the taste consistent with traditional prepared mustards. While the flavor profile may alter with the type of mustard seed used in formulation, the traditional mustard flavor used in functional mustard pastes is derived from yellow mustard seed (S. alba or B. hirta). The flavor development associated with yellow mustard seed, when used in prepared mustards and/or mustard pastes, can be described by the following reaction:

Sinalbin+Water→p-Hydroxybenzyl Isothiocyanate+Glucose+Sinalpine Acid Sulfate

This reaction is catalyzed by an enzyme, namely Myrosinase, which is naturally occurring in yellow mustard seed. The glucosinolate, particularly Sinalbin, is also naturally occurring in yellow mustard seed and reacts with water, in the presence of Myrosinase, which creates the products on the right-hand side of the reaction depicted above. p-Hydroxybenzyl Isothiocyante (“Isothiocyanate”) is the aromatic compound primarily responsible for the traditional flavor associated with prepared yellow mustard and/or mustard pastes. Glucose and Sinalpine Acid Sulfate (“Acid”), while products of the flavor reaction, are considered minor products; however, the development of Glucose and/or Acid may be used as indicators for the successful completion of the reaction, and thus, may be used to indicate the presence of the Isothiocyanate, or more generally “mustard flavor”.

When prepared mustards and/or mustard pastes are used as ingredients primarily for its functional benefits, it is often desirable to form an aqueous mustard paste that is absent of Isothiocyanate, or more generally “mustard flavor”. Prior attempts to substantially remove the mustard flavor have included attempts to deactivate the Myrosinase enzyme while it is in its dry or solid mustard seed form, i.e., prior to forming an aqueous mustard paste, resulting in what is commonly referred to as “deactivated” or “deheated” mustard seed. “Deactivated” or “deheated” mustard seed simply refers to mustard seed that, as a result of Myrosinase deactivation, is unable to generate the products on the right-hand side of the Sinalbin degradation equation described above, most notably the Isothiocyanate, or mustard flavor. However, in adding “deactivated” or “deheated” mustard seed to solvents, including water and vinegar, it has been found that the reaction, while delayed, still occurs. Accordingly, the food industry is yet to be met with a prepared mustard and/or mustard paste which demonstrates the preferred functional characteristics of viscosity-building, texture-aiding, and emulsion-strengthening, while successfully limiting the presence of “mustard flavor”.

Thus, there is a need for the formulation of a prepared mustard and/or mustard paste that exhibits enhanced functional benefits, namely viscosity, without enhancing the prevalence of mustard flavor. That is to say, there is a need for a prepared mustard and/or mustard paste that exhibits elevated functional benefits, i.e., viscosity, and a consistent or even decreased flavor profile relative to current commercially available prepared mustards and/or mustard pastes. There is also a need for processing parameters that ensure “deheated” mustard seed when used in prepared mustards and/or mustard pastes with enhanced functional benefits to maintain a limited presence of mustard flavor over an extended duration.

### SUMMARY OF THE INVENTION

Illustrative embodiments according to the invention are directed towards an aqueous mustard paste including de-oiled mustard seed, vinegar and water, wherein the resultant paste demonstrates an enhanced viscosity.

In one aspect, the invention includes a mustard paste base including a 5% by weight of a deoiled mustard seed additive.

In another aspect, the invention includes a mustard paste base including a 10% by weight of a deoiled mustard seed additive.

In another aspect, the mustard paste base is a substantially flavorless mustard paste, i.e., deheated, where the concentration of glucose in the paste is less than approximately 100 mg/dL, serving as measurable proof that the mustard flavor reaction forming isothiocyanate has not occurred. Additionally, the aqueous mustard paste should demonstrate a stable or consistent pH, and preferably a stable or consistent pH of less than 5.5, which provides additional measureable evidence that neither Sinalpine Acid Sulfate nor Isothiocyanate, i.e., mustard flavor, is present in the aqueous mustard paste.

In one aspect, the invention relates to an aqueous mustard paste having a viscosity of greater than 140,000 cP's at a solid percentage of 18.2.

In one aspect, the invention relates to an aqueous mustard paste having a viscosity of greater than 172,500 cP's at a solid percentage of 18.2.

In one aspect, the invention relates to an aqueous mustard paste having a viscosity of greater than 222,500 cP's at a solid percentage of 18.2.

In another aspect, the invention includes an acidic liquid of preferably not less than 12% titratable acidity, such as a 120 grain strength vinegar, to which yellow mustard seed is added.

In another aspect, the invention relates to an enhanced viscosity aqueous mustard paste that is substantially free of an isothiocyanate and includes a volume of ground mustard seed and a volume of an acidic liquid.

In yet another aspect of the invention, the acidic liquid may contain acetic acid, citric acid, or phosphoric acid.

In another aspect, the invention includes a deheated deoiled yellow mustard seed.

In still another aspect, the invention includes a method of manufacturing an enhanced viscosity flavorless aqueous mustard paste having a consistent pH value of less than 5.5 and a concentration of glucose less than 100 mg/dL providing the steps of combining a volume of mustard seed, a volume of an acidic, liquid and a percentage by weight of a deheated deoiled mustard seed additive, and milling the combination to form the flavorless aqueous mustard paste.

Numerous other aspects, features, and advantages of the present invention will be made apparent from the following detailed description together with the drawing figures.

### BRIEF DESCRIPTION OF THE DRAWINGS

The disclosed embodiments will be further explained with reference to the attached drawings, wherein like structures are referred to by like numerals throughout the several views. The drawings are not necessarily to scale, the emphasis having instead been generally placed upon illustrating the principles of the invention and the disclosed embodiments.

FIG. 1 shows a method of forming an enhanced viscosity mustard paste in accordance with at least one embodiment of the present invention.

FIG. 2 shows a method of forming an enhanced viscosity flavorless mustard paste in accordance with at least one embodiment of the present invention.

### DETAILED DESCRIPTION OF THE INVENTION

Illustrative embodiments according to the invention are directed towards an aqueous mustard paste. More specifically, particular illustrative embodiments described herein are directed towards an enhanced viscosity mustard paste, a substantially flavorless enhanced viscosity mustard paste, and a method of manufacturing the same.

### I. Enhanced Viscosity Mustard Paste

In one embodiment of the current invention, an aqueous mustard paste may be formed from a suspension of yellow mustard seed in vinegar with the attributes identified below in Table 1. While the attribute values identified in the following table may constitute a preferred embodiment, the indicated value range of each attribute is also considered within the scope of this invention.

TABLE 1

| Attribute | Value | Value Range |
|---|---|---|
| Moisture | 77.4% | 75-79% |
| Solids | 22.6% | 20-24% |
| Fiber | 3.1% | 2.5-3.5% |
| Viscosity | 240,000 cP's | |
| Adjusted Viscosity | 140,000 cP's | |
| at 18.2% solids | | |

Traditional aqueous mustard pastes are manufactured by means of initially combining mustard seeds in a volume of water or vinegar. While the percentage of solids and moisture in such mustard pastes may vary, traditional mustard pastes that exhibit an elevated solid component are composed of approximately 80% moisture and approximately 20% solids, of which approximately 2% is fiber. These traditional mustard pastes demonstrate a viscosity of approximately 162,500 centipoise (cP), which when diluted with liquid to a solid percentage of 18.2% is approximately equal to 125,000 cP. Because the solid component of the aqueous mustard paste is a limiting factor in determining the viscosity, i.e., functionality, of the paste, such mustard pastes have typically demonstrated a maximum attainable viscosity. That is to say, that adding additional solids beyond approximately 20% may adversely compromise either the flavor or other characteristics of the mustard paste.

Alternatively, the present inventors have identified a means of increasing the solid component of the mustard paste while still maintaining its aqueous characteristics and other benefits of the prepared mustard. Accordingly, the inventors have identified a method for manufacturing an aqueous mustard paste that exhibits enhanced viscosity without an enhanced or intensified mustard flavor.

Namely, an aqueous mustard paste according to the general formulation listed in Table 1 may be formed in one embodiment in accordance with the following method. Initially, the mustard seed, such as yellow mustard seed, and the volume of an acid liquid, such as vinegar, are combined. In one embodiment, the vinegar may be 120 grain vinegar, i.e., containing 12% acetic acid. However, higher acid concentrations in the solvent are also considered within the scope of this invention. In an alternative embodiment, the solvent may include an alternative acid solution, including preferably a food grade acid such as citric acid, phosphoric acid, etc. After these ingredients are combined, they are milled together. A aqueous mustard paste is formed as a result of the milling process.

After milling the mustard seed and vinegar together to form an aqueous mustard paste, the viscosity of the mustard paste according to the general formulation listed in Table 1 was tested using a Bookfield LVF, #6 spindle @ 2 rpm. The mustard paste of Table 1 demonstrates a viscosity of approximately 240,000 cP, which when adjusted to a constant solid percentage of 18.2% solids is approximately equal to 140,000 cP. As compared to a traditional high-solid mustard paste, the general formulation listed in Table 1 exhibited an actual viscosity increase of 77,500 cP, which when diluted with liquid to a constant solid percentage of 18.2% solids is equal to an increase of 15,000 cP.

In another embodiment of the current invention, an aqueous mustard paste may be formed from a suspension of yellow mustard seed in vinegar combined with a percentage by weight of a deoiled mustard seed, with the attributes identified below in Table 2; as is shown in the method 10 in FIG. 1. In the present embodiment, the deoiled mustard seed additive of the mustard paste identified below in Table 2 represents 5% by weight of the total mustard paste mass, however the invention is not limited to this specific percentage and other percentages, both higher and lower, are considered well within the scope of this invention. In one embodiment, the deoiled mustard seed additive may be a deheated deoiled mustard seed additive. Furthermore, the deheated deoiled mustard seed may be combined with a formulation of a flavorless mustard paste, as is defined in greater detail below, and shown in method 20 in FIG. 2, resulting in a flavorless mustard paste with enhanced viscosity and still be considered within the scope of the present invention. While the attribute values identified in the following table may constitute a preferred embodiment, the indicated value range of each attribute is also considered within the scope of this invention.

TABLE 2

| Attribute | Value | Value Range |
|---|---|---|
| Moisture | 73.8% | 70-75% |
| Solids | 26.2% | 24-28% |
| Fiber | 3.7% | 3.5-3.9% |
| Viscosity | 387,500 cP's | |
| Adjusted Viscosity | 172,500 cP's | |
| at 18.2% solids | | |

An aqueous mustard paste according to the general formulation listed in Table 2 may be formed in one embodiment by means of first pressing or otherwise feinting a deoiled mustard seed additive, as shown in block 12 of method 10 in FIG. 1. Then a volume of mustard seed and a volume of an acidic liquid, in according to the general formulation listed above in Table 1, is combined together with 5% by weight deoiled ground mustard as shown in block 14 of method 10 in FIG. 1. After combining, the ingredients are milled as shown in block 16. Resultantly, an enhanced viscosity mustard paste is formed as shown in block 18. However, it should be known that the volume of mustard seed and a volume of an acidic liquid presented in block 14 need not necessarily be in according to the general formulation listed in Table 1, and that such a formulation is included only by way of example. Furthermore, while the general formulation listed in Table 2 contains 5% by weight deoiled ground mustard, this is only presented as an exemplary embodiment of a range of percent by weight of deoiled ground mustard additive. In one embodiment the resultant enhanced viscosity mustard paste is formed of greater than 1% by weight deoiled ground mustard seed additive. In another embodiment the resultant enhanced viscosity mustard paste is formed of greater than 2% by weight deoiled ground mustard seed additive. In yet another embodiment the resultant enhanced viscosity mustard paste is formed of less than 75% by weight deoiled ground mustard seed additive. In still another embodiment the resultant enhanced viscosity mustard paste is formed of less than 95% by weight deoiled ground mustard seed additive.

The viscosity of the resultant mustard paste was tested using a Bookfield LVF, #6 spindle @ 2 rpm. The mustard paste of Table 2 demonstrates a viscosity of approximately 387,500 cP, which when diluted with liquid to a constant solid percentage of 18.2% solids is approximately equal to 172,500 cP. As compared to a traditional high solid mustard paste, the general formulation listed in Table 2 exhibited an actual viscosity increase of 225,000 cP, which when adjusted to a constant solid percentage of 18.2% solids is equal to an increase of 47,500 cP.

In yet another embodiment of the current invention, an aqueous mustard paste may be formed from a suspension of yellow mustard seed in vinegar combined with a deoiled mustard seed additive, with the attributes identified below in Table 3. In the present embodiment, the deoiled mustard seed additive of the mustard paste identified below in Table 3 represents 10% by weight of the total mustard paste mass, however the invention is not limited to this specific percentage and other percentages, both higher and lower, are considered well within the scope of this invention. In one embodiment, the deoiled mustard seed additive may be a deheated deoiled mustard seed additive. Furthermore, the deheated deoiled mustard seed may be combined with a formulation of a flavorless mustard paste, as is defined in greater detail below, and shown in method 20 in FIG. 2, resulting in a flavorless mustard paste with enhanced viscosity and still be considered within the scope of the present invention. While the attribute values identified in the following table may constitute a preferred embodiment, the indicated value range of each attribute is also considered within the scope of this invention.

TABLE 3

| Attribute | Value | Value Range |
|---|---|---|
| Moisture | 68.7% | 68-70% |
| Solids | 31.3% | 28-32% |
| Fiber | 4.3% | 4.0-4.5% |
| Viscosity | 480,000 cP's | |
| Adjusted Viscosity | 222,500 cP's | |
| at 18.2% solids | | |

An aqueous mustard paste according to the general formulation listed in Table 3 may be formed in one embodiment by means of first pressing or otherwise forming a deoiled mustard seed additive, as shown in block 12 of method 10 in FIG. 1. Then a volume of mustard seed and a volume of an acidic liquid, in according to the general formulation listed above in Table 1, is combined together with 10% by weight deoiled ground mustard as shown in block 14 of method 10 in FIG. 1. After combining, the ingredients are milled as shown in block 16. Resultantly, an enhanced viscosity mustard paste is formed as shown in block 18. However, it should be known that the volume of mustard seed and a volume of an acidic liquid presented in block 14 need not necessarily be in according to the general formulation listed in Table 1, and that such a formulation is included only by way of example. Furthermore, while the general formulation listed in Table 3 contains 10% by weight deoiled ground mustard, this is only presented as an exemplary embodiment of a range of percent by weight of deoiled ground mustard additive. In one embodiment the resultant enhanced viscosity mustard paste is formed of greater than 1% by weight deoiled ground mustard seed additive. In another embodiment the resultant enhanced viscosity mustard paste is formed of greater than 2% by weight deoiled ground mustard seed additive. In yet another embodiment the resultant enhanced viscosity mustard paste is formed of less than 75% by weight deoiled ground mustard seed additive. In still another embodiment the resultant enhanced viscosity mustard paste is formed of less than 95% by weight deoiled ground mustard seed additive.

The viscosity of the resultant mustard paste in according to the general formulation listed in Table 3 was tested using a Bookfield LVF, #6 spindle @ 2 rpm. The mustard paste of Table 3 demonstrates a viscosity of approximately 480,000 cP, which when diluted with liquid to a constant solid percentage of 18.2% solids is approximately equal to 222,500 cP. As compared to a traditional high solid mustard paste, the general formulation listed in Table 2 exhibited an actual viscosity increase of 317,500 cP, which when adjusted to a constant solid percentage of 18.2% solids is equal to an increase of 97,500 cP.

### II. Substantially Flavorless Enhanced Viscosity Mustard Paste

In one embodiment of the current invention, the enhanced viscosity mustard pastes identified above in Tables 2 and 3, namely those including a 5% and 10% by weight additive of a deheated deoiled mustard seed to an aqueous mustard paste, may utilize a substantially flavorless aqueous mustard paste formed from a suspension of yellow mustard seed in vinegar as follows below in Table 4. While the weight and percent weight of those ingredients identified in the following table may constitute a preferred embodiment, the indicated range in percent weight of each ingredient is also considered within the scope of this invention. Furthermore, while the deoiled mustard seed additive of the mustard paste identified below in Tables 2 and 3 represent 5% and 10% by weight of the total mustard paste mass, respectively, the invention is not limited to these specific percentages and other percentages, both higher and lower, are considered well within the scope of this invention.

TABLE 4

| Ingredient | Grams | Percent weight | Range in percent weight |
|---|---|---|---|
| Mustard Seed | 30.0 | 20.8 | 15-30% |
| Vinegar | 114.0 | 79.2 | 70-85% |

An aqueous mustard paste according to the general formulation listed in Table 4 may be formed in one embodiment in accordance with the method 20 depicted in FIG. 2. First, the deheated deoiled mustard seed additive is pressed or otherwise formed, as shown in block 22 of method 20 in FIG. 2. Then, the mustard seed and the volume of an acid liquid, such as vinegar are combined with the deheated deoiled mustard seed additive, as seen in block 24. In one embodiment, the vinegar may be 120 grain vinegar, i.e., containing 12% acetic acid. However, higher acid concentrations in the solvent are also considered within the scope of this invention. In an alternative embodiment, the solvent may include an alternative acid solution, including preferably a food grade acid such as citric acid, phosphoric acid, etc. The concentration of such acid solutions may vary as is necessary to inhibit the activation of the Myrosinase enzyme. After these ingredients are combined, they are milled together as shown in block 26. A flavorless enhanced viscosity mustard paste is formed as a result of the milling process, as is shown in block 28. It is thought that the presence of the vinegar interferes with and inhibits the activation of the Myrosinase enzyme as to prevent the hydrolysis of the glucosinolate sinalbin; however, the present invention is in no way limited to this mode of operation.

After milling to form an aqueous mustard paste, glucose tests were conducted over a period of 24 hours. As glucose is a product of sinalbin hydrolysis via the myrosinase enzyme, the presence of glucose provides an effective quantitative indication of myrosinase activity. In one embodiment of the current invention, multiple glucose tests were administered to both the aqueous mustard paste according to the formulation specified in Table 4 and an aqueous mustard paste in which 16.6% of the vinegar was replaced with water.

According to these glucose tests, the results of which are provided below in Table 5, positive results indicate a glucose level of greater than 100 mg/dL, i.e., 0.1%, while negative results indicate of glucose level of less than 100 mg/dL, i.e., 0.1%. In Table 2, below “V” stands for vinegar, “S” stands for seed, and “W” stands for water. The term “V+S+W after 5 minutes” means that water is added five minutes after the vinegar and seed were mixed together. The term “V+S+W after 10 minutes” means that the water is added 10 minutes after the vinegar and seed were mixed together. The term “V+S+W after 15 minutes” means that the water is added 15 minutes after the vinegar and seed were mixed together.

TABLE 5

| | | | | | | Glucose | Glucose | | | |
|---|---|---|---|---|---|---|---|---|---|---|
| | | | | | | Present | Present | | | |
| | | | | | | After | After | | | |
| | | | | | Acidity from | Adding | Adding | Results After | Results After | Results After |
| Prototype Results | Seed (g) | Vinegar (g) | Water (g) | Vinegar Grain | Vinegar (%) | Vinegar | Water | 2.5 hours | 18 hours | 24 hours |
| A (V + S) | 30 | 38 | — | 120 | 6.71 | − | − | + | + | + |
| A (V + S + W after | 30 | 38 | 76 | 40 | 3.17 | − | − | + | + | + |
| 5 minutes) | | | | | | | | | | |
| A (V + S + W after | 30 | 38 | 76 | 40 | 3.17 | − | − | + | + | + |
| 10 minutes) | | | | | | | | | | |
| A (V + S + W after | 30 | 38 | 76 | 40 | 3.17 | − | − | + | + | + |
| 15 minutes) | | | | | | | | | | |
| B (V + S) | 30 | 57 | — | 120 | 7.86 | − | − | + | + | + |
| B (V + S + W after | 30 | 57 | 57 | 60 | 4.75 | − | − | + | + | + |
| 5 minutes) | | | | | | | | | | |
| B (V + S + W after | 30 | 57 | 57 | 60 | 4.75 | − | − | + | + | + |
| 10 minutes) | | | | | | | | | | |
| B (V + S + W after | 30 | 57 | 57 | 60 | 4.75 | − | − | + | + | + |
| 15 minutes) | | | | | | | | | | |
| C (V + S) | 30 | 76 | — | 120 | 8.60 | − | − | − | + | + |
| C (V + S + W after | 30 | 76 | 38 | 80 | 6.33 | − | − | − | + | + |
| 5 minutes) | | | | | | | | | | |
| C (V + S + W after | 30 | 76 | 38 | 80 | 6.33 | − | − | − | + | + |
| 10 minutes) | | | | | | | | | | |
| C (V + S + W after | 30 | 76 | 38 | 80 | 6.33 | − | − | − | + | + |
| 15 minutes) | | | | | | | | | | |
| D (V + S) | 30 | 95 | — | 120 | 9.12 | − | − | − | − | − |
| D (V + S + W after | 30 | 95 | 19 | 100 | 7.93 | − | − | − | + | + |
| 5 minutes) | | | | | | | | | | |
| D (V + S + W after | 30 | 95 | 19 | 100 | 7.93 | − | − | − | + | + |
| 10 minutes) | | | | | | | | | | |
| D (V + S + W after | 30 | 95 | 19 | 100 | 7.93 | − | − | − | + | + |
| 15 minutes) | | | | | | | | | | |
| E (V + S) | 30 | 114 | — | 120 | 9.50 | − | − | − | − | − |

Referring to Table 5, the first trial using the “deheated” mustard seed instead of regular mustard seed was conducted. According to the experimental protocol, each step was tested properly and all tests indicated that the aqueous mustard paste produced was successfully deheated and indicated no flavor development immediately following the addition of vinegar and water. However, after 2.5 hours, the aqueous mustard paste started to show the development of flavor, detected by the positive result of the glucose test. Thus, additional experiments were conducted. To ensure that the glucose test is accurate, several regular dry ground mustard products were tested as a control group. All of these results indicated immediate glucose production, which shows that the glucose test is a valid test to be used in this product development.

As shown in Table 5, an experiment was then conducted to determine whether the vinegar concentration will prevent the Myrosinase enzymatic reaction from occurring. Still referring to Table 5, the findings prove that the level of vinegar concentration is critical to prevent the activation of the Myrosinase enzymatic reaction.

Accordingly, as indicated in Table 5, the aqueous mustard paste according to the formulation specified in Table 4, which is listed as prototype E in Table 5, produced no discernible glucose, i.e., less than 100 mg/dL, i.e., 0.1%, over a course of 24 hours. This lack of glucose indicates that Myrosinase enzyme has not been activated, thereby quantitatively confirming that the aqueous mustard paste according to an embodiment of the present invention is substantially flavorless. The substantially flavorless nature of this aqueous mustard paste was then further confirmed by means of qualitative verification.

In another embodiment of the current invention, the enhanced viscosity mustard pastes identified above in Tables 2 and 3, namely those including a 5% and 10% by weight additive of a deheated deoiled mustard seed to an aqueous mustard paste, may utilize a substantially flavorless aqueous mustard paste formed from a suspension of deheated yellow mustard seed in vinegar as follows below in Table 6. While the proportions of those ingredients identified in the following table may constitute a preferred embodiment, the indicated range in percent weight of each ingredient is also considered within the scope of this invention,

TABLE 6

| Ingredient | Grams | Percent weight | Range in percent weight |
|---|---|---|---|
| Defeated Mustard | 30.0 | 15.0% | 12-30% |
| Seed | | | |
| Vinegar 120 grain | 170.0 | 85.0% | 70-88% |

In one embodiment, the mustard seed may include a deheated yellow mustard seed. The method of forming an aqueous mustard paste containing deheated mustard may include the initial step of exposing the mustard seed to elevated temperatures and/or pressures resulting in the inactivation of the Myrosinase enzyme. In one embodiment, exposure to pressure of approximately 100 to 150 kPa for a period of 10.0 to 15.0 minutes may result in the inactivation of the Myrosinase. After deheating, the mustard is then ground and combined with a volume of vinegar. In one embodiment, the vinegar may be 120 grain vinegar, i.e., contained 12% by weight acetic acid. After these ingredients are combined, they are milled together to form an aqueous mustard paste.

The aqueous mustard paste as described in Table 6 was shown to have an initial pH of approximately less than 3.5. After a period of 24 hours, the aqueous mustard paste as described in Table 6 was shown to have a maintained stable or consistent pH of approximately less than 3.5. This is evidence that the enzymatic reaction was prevented from occurring; otherwise, a drop in pH would be expected as a result of the acid produced by the reaction.

The aqueous mustard paste as described in Table 6 was shown to have an initial glucose level of less than 0.1%. After 2.5, 18 and 24 hours, the glucose level remained at less than 100 mg/dL, i.e., 0.1%. This is additional supporting evidence that the enzymatic reaction did not take place.

The aqueous mustard paste as described in Table 6 was further shown to maintain its functional characteristics while being substantially flavorless, substantially free of isothiocyanate.

Certain embodiments according to the invention have been disclosed. These embodiments are illustrative of, and not limiting on, the invention. Other embodiments, as well as various modifications and combinations of the disclosed embodiments, are possible and are within the scope of this disclosure. Various other embodiments of the present invention are contemplated as being within the scope of the filed claims particularly pointing out and distinctly claiming the subject matter regarded as the invention.

1. An enhanced viscosity aqueous mustard paste comprising:
a volume of mustard seed;
a volume of vinegar; and
a deoiled mustard seed additive.

2. The enhanced viscosity aqueous mustard paste of claim 1 including at least 5% weight of the deoiled, mustard seed additive.

3. The enhanced viscosity aqueous mustard paste of claim 1 having a viscosity of at least 140,000 cP when the percent of solids by weight of the mustard paste equals 18.2.

4. The enhanced viscosity aqueous mustard paste of claim 3 having a viscosity of at least 172,500 cP when the percent of solids by weight of the mustard paste equals 18.2.

5. The enhanced viscosity aqueous mustard paste of claim 4 having a viscosity of at least 222,500 cP when the percent of solids by weight of the mustard paste equals 18.2.

6. The enhanced viscosity aqueous mustard paste of claim 1 wherein the deoiled mustard seed additive is deheated.

7. An enhanced viscosity mustard paste comprising:
a volume of mustard seed;
a volume of vinegar;
a deheated deoiled mustard seed additive;
a concentration of glucose less than 100 mg/dl; and
the flavorless aqueous mustard paste having a substantially stable pH value of less than 5.5.

8. The enhanced viscosity aqueous mustard paste of claim 6 including at least 5% weight of the deheated deoiled mustard seed additive.

9. The enhanced viscosity aqueous mustard paste of claim 6 having a viscosity of at least 140,000 cP when the percent of solids by weight of the mustard paste equals 18.2.

10. The enhanced viscosity aqueous mustard paste of claim 8 having a viscosity of at least 172,500 cP when the percent of solids by weight of the mustard paste equals 18.2.

11. The enhanced viscosity aqueous mustard paste of claim 9 having a viscosity of at least 222,500 cP when the percent of solids by weight of the mustard paste equals 18.2.

12. The enhanced viscosity mustard paste of claim 6, that is substantially free of an isothiocyanate.

13. The enhanced viscosity mustard paste of claim 11, wherein the isothiocyanate is p-hyrdroxybenzyl isothiocyanate.

14. The enhanced viscosity mustard paste of claim 6, wherein the vinegar is formed of at least 12 percent acetic acid.

15. The enhanced viscosity mustard paste of claim 6, having a substantially stable pH value of less than 5.5.

16. The enhanced viscosity mustard paste of claim 6, wherein the mustard seed is deheated mustard seed.

17. A method of manufacturing an enhanced viscosity aqueous mustard paste, comprising the steps of:
combining a volume of mustard seed and a volume of an acidic liquid;
milling the volume of mustard seed and the volume of acidic liquid to form a mustard paste; and
adding a deoiled mustard seed additive to the mustard paste to form the enhanced viscosity aqueous mustard paste.

18. The method of claim 17, including the step of increasing the viscosity of a food product by adding the enhanced viscosity aqueous mustard paste to the food product.

19. The method of claim 16, wherein the deoiled mustard seed additive is deheated and the enhanced viscosity aqueous mustard paste has a constant pH value of less than 5.5 and a; concentration of glucose less than 100 mg/dL.

20. The method of claim 18, including the step of increasing the viscosity of a food product by adding the enhanced viscosity aqueous mustard paste to the food product.
